(19) United States
(12) Patent Application Publication
(10) Pub. No.: US 2022/0042798 A1
(43) Pub. Date: Feb. 10, 2022

(54) METHOD FOR CHECKING THE QUALITY OF A WORKPIECE, AND COMPUTING DEVICE

(71) Applicant: Siemens Aktiengesellschaft, 80333 München (DE)

(72) Inventor: Adel Haghani, Würzburg (DE)

(73) Assignee: Siemens Aktiengesellschaft, 80333 München (DE)

(21) Appl. No.: 17/431,068

(22) PCT Filed: Feb. 12, 2020
(86) PCT No.: PCT/EP2020/053519

§ 371 Date: Aug. 13, 2021

(30) Foreign Application Priority Data
Feb. 14, 2019 (EP) 19157157.9

(51) Int. Cl. G01B 21/20

(52) U.S. Cl. CPC G01B 21/20

(57) ABSTRACT

In a method for checking the quality of a workpiece, measurement values which describe outer dimensions of the workpiece are measured along the workpiece at predefined points in time, generating a measurement signal. A difference signal representing a difference between the measurement signal and a reference measurement signal describing a reference workpiece is determined, and therefrom a frequency spectrum of the differential signal is determined. The quality of the workpiece is assessed based on the presence of at least one predefined oscillation, and a frequency spectrum of the differential signal is determined for each of a plurality of specified frequency ranges. A frequency spectrum is determined for the reference measurement signal and, based on the frequency spectrum for the reference measurement signal, a permissible range is determined for each of the specified frequency ranges.

The present invention relates to a method for checking a quality of a workpiece. In the case of the method, a determined measurement signal is received, wherein measurement values are recorded so as to determine the measurement signal at predetermined points in time. In this case, the measurement values describe outer dimensions of the workpiece. Furthermore, a reference measurement signal is provided, wherein the reference measurement signal describes a measurement signal of a reference workpiece. Furthermore, a difference signal is determined with the aid of a difference between the measurement signal and the reference measurement signal. The quality of the workpiece is then checked with the aid of the difference signal. Furthermore, the present invention relates to a computing facility for an inspection system for checking a quality of a workpiece.

Various methods for checking a quality of a workpiece are known from the prior art. In the case of one such method, a check is to be performed in particular as to whether the spatial dimensions of the workpiece lie within a predetermined tolerance range. Such methods can be used in the case of different workpieces. For example, the quality of workpieces can be checked at the end of the manufacturing process. In addition, it is possible to check whether workpieces have been subjected to wear during use.

Moreover, it is known from the prior art that the workpiece will be measured accordingly so as to check the quality. For this purpose, an appropriate measuring facility can be used, by means of which the outer dimensions of the workpiece can be determined. For example, the workpiece can be measured by means of the measuring facility at predetermined points in time at predetermined positions. On the basis of these measurement values, it is then possible to generate a measurement signal that in turn can be compared with a reference measurement signal. This reference measurement signal originates from measurements taken on a reference workpiece that has the target dimensions. Furthermore, a difference signal can be determined that describes a difference between the measurement signal and the reference measurement signal. If the difference signal lies in a predetermined tolerance range, the quality of the workpiece can be regarded as being sufficient. If the difference signal lies outside the tolerance range, then in contrast it can be assumed that the quality of the workpiece is insufficient.

DE 10 2015 013 607 A1 discloses a system for measuring a component, wherein the system comprises a controller that is connected to a measurement sensor and an actuator. The controller is embodied so as to receive coordinates of the target points of the intended shape, to determine coordinates of the actual target points of the component relative to one or multiple component reference variables based on the signals and to compare the coordinates of the target points of the intended shape with the coordinates of the actual target points. Furthermore, the controller is embodied so as to create a deviation report based on the comparison, and to filter information from the deviation report according to a wave length into multiple deviation categories according to the component specification requirements of the component.

Moreover, an apparatus for inspecting surface defects is known from JP H11 281336 A. The apparatus comprises contact bodies that are arranged in such a manner that they are brought into contact at a prescribed distance in the circumferential direction of a body that is to be inspected. The contact bodies can be rotated synchronously and the protrusions from the surface of the body to be inspected are inspected by displacement measuring facilities. If the positions of the two protrusions correspond in the recorded data to a prescribed interval, an assessment means concludes that the protrusions are surface defects.

E. Rubio et al: “A Wavelet Approach to Estimate the Quality of Ground Parts”, Journal of applied research and technology, 2012, describes a method for determining quality of workpieces with the aid of a wavelet analysis of measurement signals.

It is the object of the present invention to provide a solution whereby the quality of a workpiece of the type mentioned in the introduction can be reliably determined in a simple manner.

This object is achieved in accordance with the invention by a method, by a computing facility and by a computer program having the features as claimed in the independent claims. Advantageous developments of the present invention are disclosed in the dependent claims.

The method in accordance with the invention serves to check a quality of a workpiece. The method includes the procedure of receiving a determined measurement signal, wherein so as to determine the measurement signal at predetermined points in time measurement values that describe outer dimensions of the workpiece are recorded along the workpiece. Furthermore, the method includes the procedure of providing a reference measurement signal wherein the reference measurement signal describes a measurement signal of a reference workpiece. Moreover, the method includes the procedure of determining a difference signal with the aid of a difference between the measurement signal and the reference measurement signal. Furthermore, the method includes the procedure of checking the quality of the workpiece with the aid of the difference signal. In so doing, it is provided that a frequency spectrum of the difference signal is determined and a check is performed as to whether at least one predetermined oscillation is present in the frequency spectrum. Furthermore, the quality of the workpiece is checked with the aid of the presence of the at least one predetermined oscillation.

The quality of a workpiece is to be checked with the aid of the method. In particular, it is possible using the method to check whether the outer dimensions of the workpiece and/or a surface condition corresponds to the desired specifications. The workpiece can be produced or manufactured by means of a machine tool for example. For example, the workpiece can be produced by a machining process, an additive manufacturing process, a forming procedure, a molding procedure, a press method, a print method or the like. The workpiece can be manufactured from a metal, a ceramic or a synthetic material. It can also be provided that the quality of the workpiece is checked after its utilization or use. It is possible in this manner to ascertain whether the workpiece has experienced wear and/or has been damaged. An appropriate inspection system or a machine tool can be used to check the quality of the workpiece. This inspection system can have a measuring facility by means of which the measurement values can be provided. These measurement values describe the outer dimensions of the workpiece. The measurement values can therefore describe the extension of the workpiece in at least one spatial direction. Furthermore, the measurement values can describe a surface condition of the workpiece. By means of the measuring facility, the measurement values can be determined at predetermined points in time or at a predetermined sampling rate. In so doing, it is provided in particular that the measuring facility is moved along a first extension direction of the workpiece and in so doing the measurement values are recorded. The measurement values can describe the extension of the workpiece in a second extension direction. The temporal progression of the measurement values or the measurement values that are recorded at predetermined points in time can then be combined in the measurement signal.

Furthermore, the reference measurement signal is provided. This reference measurement signal describes a measurement signal from a reference workpiece. This reference workpiece serves as a reference for the workpiece that is to be manufactured. This reference workpiece corresponds in particular with respect to the outer dimensions and/or the surface condition to the target specifications. The reference measurement signal is determined in a similar manner to the measurement signal. Furthermore, the difference signal is determined that describes a difference between the measurement signal and the reference measurement signal. This difference signal is now utilized to check the quality of the workpiece.

In accordance with one essential aspect of the invention, it is provided that a frequency spectrum of the difference signal is determined. It is possible in this manner to examine the individual frequency components of the difference signal. A check is now performed as to whether a predetermined oscillation or predetermined oscillations are present in the frequency spectrum. The quality of the workpiece is checked on the basis of the presence of the predetermined oscillation. The present invention is based on the knowledge that the difference signal can have corresponding fluctuations if the outer shape or the outer dimensions of the workpiece deviate from those of the reference workpiece. In the case of the method known from the prior art, a check is only performed as to whether the amplitude of the difference signal lies within a predetermined tolerance range. In so doing, the case can arise that deviations of the outer dimensions and/or the surface condition of the workpiece that deviate from the reference workpiece cannot be reliably detected. By evaluating the frequency spectrum of the difference signal, these deviations can be detected in a reliable manner. It has been established that specific deviations of the workpiece from the reference workpiece can be detected on the basis of fluctuations in the difference signal. These oscillations usually occur in a specific frequency range. These fluctuations or oscillations can be detected by determining the frequency spectrum of the difference signal. Overall, the quality of the workpiece can consequently be reliably checked in a simple manner.

In addition, a plurality of frequency ranges is specified and a frequency spectrum of the difference signal is determined respectively for the plurality of frequency ranges. The difference signal can therefore be evaluated in different frequency ranges or frequency bands. Consequently, a check can be performed as to whether the predetermined oscillation or a predetermined oscillation is present in the respective frequency ranges. Alternatively or in addition thereto, it can be provided that the difference signal is evaluated for a plurality of time regions. In tests, it can be determined whether the oscillations occur in specific frequency ranges and/or time ranges. In dependence upon the result of the tests, individual time ranges and/or frequency ranges can then be purposefully checked as to whether they have this predetermined oscillation in the frequency spectrum.

In a further embodiment, the frequency spectra are determined for the plurality of frequency ranges by means of a wavelet transform. It is possible for example to perform a wavelet analysis in which a transition from the temporal representation into the spectral representation is performed. In so doing, the basic function that is used for the wavelet transform in this case can be adapted according to the desired frequency ranges. A simple and reliable evaluation of the frequency ranges can be performed by the wavelet transform or the wavelet analysis.

Moreover, a frequency spectrum for the reference measurement signal is determined and with the aid of the frequency spectrum for the reference measurement signal a permissible range is determined for the respective frequency ranges. Furthermore, it is preferred that a check is performed as to whether an amplitude of the frequency spectrum of the difference signal lies in the permissible ranges for the respective frequency ranges. The frequency spectrum for a reference workpiece can be determined on the basis of the reference measurement signal. In particular, it is provided that the frequency spectrum is determined respectively from a plurality of reference workpieces. For the defined frequency ranges and/or time ranges, it is then possible to determine the average value and/or the variance for the amplitude of the spectrum. This then renders it possible to determine the permissible range for the amplitude of the frequency spectrum in the respective frequency range. If it is possible during the check on the workpiece to determine the frequency spectrum, this can be compared with the permissible range. In the event that the amplitude of the frequency spectrum lies within the permissible range, the quality of the workpiece can be regarded as being sufficient. However, in the event that the amplitude of the frequency spectrum lies outside the permissible range, the quality of the workpiece can be assumed to be insufficient. Consequently, the quality of the workpiece can be determined with little computing effort and yet reliably.

It is preferred that the quality of the workpiece is classified as insufficient if the frequency spectrum has the at least one predetermined oscillation. The presence of the predetermined oscillation in the frequency spectrum can be determined in particular with the aid of an amplitude or power of the frequency spectrum. In so doing, it is in particular provided that a check is performed as to whether this oscillation is present in a predetermined frequency range. In the event that this oscillation is not detected, the quality of the workpiece can be classified as sufficient. In this manner, the quality of the workpiece can be determined in a simple manner.

Moreover, it can be provided that in parallel to evaluating the frequency spectrum of the difference signal a check is performed as to whether the amplitude of the difference signal lies within the predetermined tolerance range. As a result, the procedure of determining the quality of the workpiece can be performed more precisely.

In a further embodiment, a noise range is defined in the frequency spectrum, wherein during the procedure of checking the quality of the work piece the noise range is not taken into consideration. Studies have shown that high frequency components of the difference signal can originate from measurement noises. These high frequency components that are allocated to the predetermined noise range can be disregarded during the procedure of checking the quality of the workpiece. In addition, it can be provided that predetermined interferences with typical frequencies are not taken into consideration during the procedure of checking the quality of the workpiece. For example, oscillations in the range of 50 Hz, which originate from the network frequency or from a voltage supply of the measuring facility, can be disregarded during the procedure of checking the quality. It is thus possible to realize that during the procedure of evaluating the frequency spectrum only the irrelevant signal components which describe in particular oscillations of the difference signal are taken into consideration.

Furthermore, it is advantageous if the measurement values describe an extension of the workpiece in the vertical direction of the workpiece for respective positions along a longitudinal direction of the workpiece. As already explained, the measurement values can be recorded by means of an appropriate measuring facility. The measuring facility can in this case measure the extension in the vertical direction of the workpiece. For this purpose, the measuring facility or a part thereof contact the workpiece. It is also possible to provide that the measurement values are recorded in a contactless manner. For example, the measuring facility can have an appropriate encoder. In order to record the measurement values, the measuring facility can be moved along the longitudinal direction of the workpiece. It is also possible to provide that the workpiece is moved relative to the measuring facility. In so doing, it is in particular provided that the relative movement of the workpiece with respect to the measuring facility is performed at a constant speed. The measurement values are then recorded at the predetermined points in time. Thus, a temporal sequence is created of the measurement values that are allocated to respective positions along the longitudinal direction of the workpiece. The temporal sequence of measurement values describes the measurement signal.

A computing facility in accordance with the invention for an inspection system for checking a quality of a workpiece is embodied so as to perform a method in accordance with the invention and the advantageous configurations thereof. The computing facility can be a processor, a digital signal processor, an application-specific specific circuit, a computer or the like. A computer program can be implemented on the computing facility.

An inspection system in accordance with the invention comprises a computing facility in accordance with the invention. The inspection system can be formed by an appropriate machine tool. Furthermore, the inspection system can have a measuring facility by means of which the measurement values are provided. These measurement values can then be transmitted to the computing facility. The reference workpieces can be stored in a corresponding memory device of the inspection system. These can then likewise be supplied to the computing facility. It is then possible by means of the computing facility to determine the difference signal and the frequency spectrum of the difference signal can be determined. It is then possible on the basis of the frequency spectrum to determine the quality of the workpiece by means of the computing facility.

A computer program in accordance with the invention comprises commands that during the implementation of the program or computer program by a computing facility cause said computing facility to perform the method. A further aspect of the invention relates to a computer-readable (memory storage) medium that comprises commands that during the implementation by means of a computing facility cause said computing facility to perform the method in accordance with the invention and the advantageous configurations.

The preferred embodiments that are presented with regard to the method in accordance with the invention and their advantages apply accordingly for the computing facility in accordance with the invention, for the inspection system in accordance with the invention, for the computer program in accordance with the invention and for the computer-readable memory storage device (medium) in accordance with the invention.

Further features of the invention are disclosed in the claims, the figures and the description of the figures. The features and feature combinations mentioned above in the description and the features and feature combinations mentioned below in the description of the figures and/or only illustrated in the figures cannot only be used in the respectively mentioned combination but rather can also be used in other combinations without departing from the scope of the invention.

The invention is now further explained with the aid of preferred exemplary embodiments and with reference to the attached drawings. In the drawings:

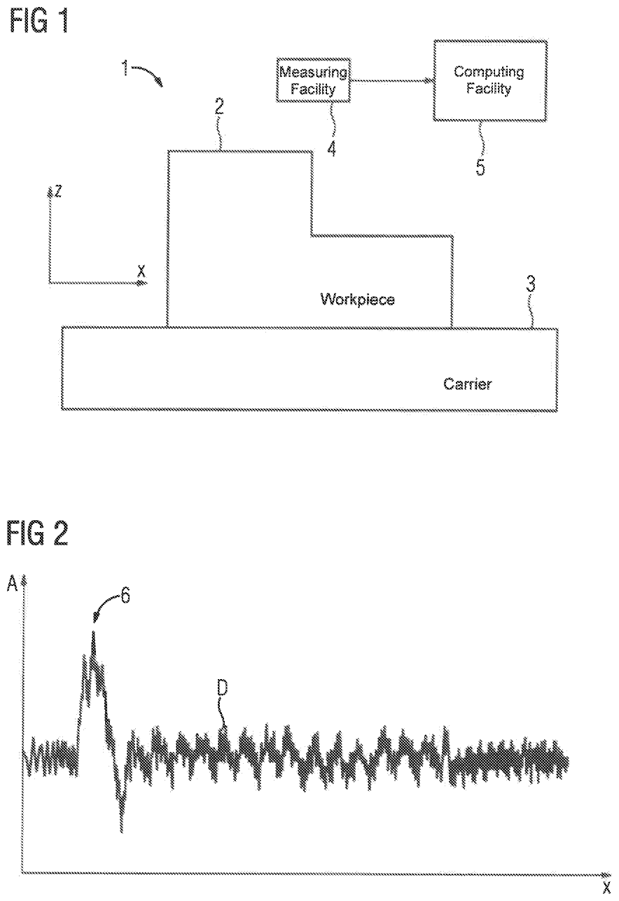

FIG. 1 shows in a schematic illustration an inspection system for checking a quality of a workpiece;

FIG. 2 shows a graph of a difference signal that describes a difference between a measurement signal, which describes the workpiece, and a reference measurement signal;

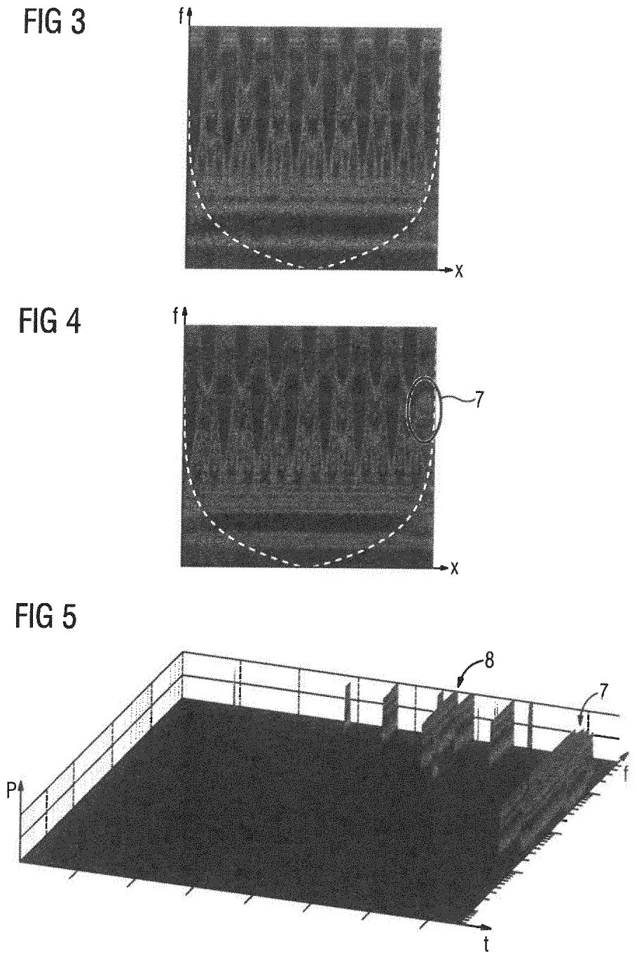

FIG. 3 shows a wavelet transform of a reference signal;

FIG. 4 shows a wavelet transform of a difference signal;

FIG. 5 shows a further illustration of a wavelet transform of a difference signal.

Like or like-functioning elements are provided with the same reference characters in the figures.

FIG. 1 shows a greatly simplified schematic illustration of an inspection system 1. This inspection system 1 renders it possible to check a quality of a workpiece 2. The workpiece 2 can be produced by an arbitrary production process. By means of the inspection system 1, a check is to be performed in particular as to whether outer dimensions of the workpiece 2 lie in a predetermined tolerance range. The workpiece 2 is arranged for the checking procedure in the present case on a carrier 3. By means of a measuring facility 4 of the inspection system 1, measurement values are provided which describe the outer dimensions of the workpiece 2. For example, the measuring facility 4 can be moved along a longitudinal direction X of the workpiece 2. At predetermined points in time, a measurement value can then be recorded in each case by means of the measuring facility 4, said measurement value describing for example an extension of the workpiece 2 along a vertical direction Z of the workpiece 2.

The temporal graph of the measurement values or the measurement values that are recorded along the longitudinal direction X form a measurement signal. This measurement signal can be supplied to a computing facility 5 of the inspection system 1. In addition, a reference measurement signal can be stored in the computing facility 5 or in an appropriate memory storage device of the computing facility 5. This reference measurement signal originates from a measurement performed on at least one reference workpiece. By means of the computing facility 5, a difference signal D can be determined which describes a difference or a difference between the measurement signal and the reference measurement signal. In addition, in order to determine the difference signal D, a computer program can be performed on the computing facility 5.

For this purpose, FIG. 2 illustrates for example a graph of a difference signal D. In this case, the longitudinal direction X of the workpiece 2 or the time t is plotted on the abscissa and an amplitude A of the difference signal D is plotted on the ordinate. In accordance with the prior art, a check is performed as to whether the amplitude A of the difference signal D lies within a predetermined tolerance range. The tolerance range can be for example a so-called 3 sigma range that is determined on the basis of a normal distribution. In the present case, the difference signal has an oscillation 6 but this lies within the tolerance range. Consequently, using a method in accordance with the prior art the quality of the workpiece 2 would have been assessed as sufficient. However, upon closer examination it can be seen that the difference signal D has an oscillation 7 in this range. These oscillations originate from a deviation of the outer dimensions of the workpiece 2 in comparison to the reference workpiece or the target dimensions. In order to be able to detect this oscillation 7, the frequency range of the difference signal D is examined.

For this purpose, FIG. 3 illustrates a wavelet transform of a reference measurement signal. In so doing, the longitudinal direction X of the workpiece 2 or the time tis plotted on the abscissa. The frequency f is plotted on the ordinate. With the aid of the wavelet transform, it is possible to determine for different frequency ranges and/or time ranges a frequency spectrum of the difference signal D. In so doing, FIG. 3 illustrates a wavelet transform for the reference workpiece.

In comparison thereto, FIG. 4 illustrates a wavelet transform of a difference signal D. In this case, oscillations that can be allocated to the difference signal D are clearly apparent in a range 7. Furthermore, these oscillations 7 can be allocated to a defined range with regard to the longitudinal direction X of the workpiece 2. The wavelet transform can be performed by means of the computing facility 5. For this purpose, an appropriate computer program can be implemented on the computing facility 5. It is thus possible by means of the computing facility 5 to detect the deviation of the workpiece 2 from a reference workpiece. It is also possible to provide that the result of the wavelet transform is displayed by means of a display facility of the inspection system 1. A person who performs the procedure of checking the quality of the workpiece 2 can thus evaluate the results of the wavelet transform. In parallel to the procedure of evaluating the frequency spectrum or the wavelet transform, it is possible to perform a check as to whether the amplitude A of the difference signal D lies within the predetermined tolerance range.

FIG. 5 illustrates a wavelet transform in a three dimensional illustration. In this case, in dependence upon the time t or the longitudinal direction X of the workpiece 2 and the frequency f, the amplitude P or the power of the frequency spectrum is illustrated. It is possible to determine in the frequency spectrum a noise range 8 that is allocated in the present case to the high frequency components of the difference signal D. Signal components that originate from the measurement noises can be present in this noise range 8. These signal components can be disregarded during the procedure of determining the quality of the workpiece 2. In the case of the present wavelet transform, the predetermined oscillations 7 can be clearly apparent in the difference signal D. By virtue of the fact that these oscillations 7 are present in the difference signal D, it can be assumed from this that the quality of the workpiece 2 is not sufficient.

1.-8. (canceled)

9. A method for checking a quality of a workpiece, comprising:
measuring along the workpiece at predetermined points in time measurement values that describe an outer dimension of the workpiece and generating therefrom a measurement signal;
providing a reference measurement signal that describes a measurement signal of a reference workpiece;
determining a difference signal representing a difference between the measurement signal and the reference measurement signal;
checking whether at least one predetermined oscillation is present in the frequency spectrum of the difference signal;
deter fining a frequency spectrum of the difference signal for a plurality of specified frequency ranges;
determining a frequency spectrum for the reference measurement signal and determining, based on the frequency spectrum for the reference measurement signal, a respective permissible range in the specified frequency ranges; and
checking the quality of the workpiece based on whether an amplitude of the frequency spectrum of the difference signal lies in the respective permissible range for the specified frequency ranges.

10. The method of claim 9, further comprising classifying the quality of the workpiece as insufficient when the frequency spectrum of the difference signal has the at least one predetermined oscillation.

11. The method of claim 9, further comprising determining the frequency spectrum of the difference signal for the plurality of frequency ranges by using a wavelet transform.

12. The method of claim 9, further comprising
defining a noise range in the frequency spectrum of the difference signal, and
assessing the quality of the workpiece without taking into consideration the noise range.

13. The method of claim 9, wherein the measurement values describe an extent of the workpiece in a vertical direction of the workpiece for positions along a longitudinal direction of the workpiece.

14. A computing facility for an inspection system constructed to check a quality of a workpiece, wherein the computing facility is configured to
measure along the workpiece at predetermined points in time measurement values that describe an outer dimension of the workpiece and generating therefrom a measurement signal;
provide a reference measurement signal that describes a measurement signal of a reference workpiece;
determine a difference signal representing a difference between the measurement signal and the reference measurement signal;
check whether at least one predetermined oscillation is present in the frequency spectrum of the difference signal;
determine a frequency spectrum of the difference signal for a plurality of specified frequency ranges;
determine a frequency spectrum for the reference measurement signal and determine, based on the frequency spectrum for the reference measurement signal, a respective permissible range in the specified frequency ranges; and
check the quality of the workpiece based on whether an amplitude of the frequency spectrum of the difference signal lies in the respective permissible range for the specified frequency ranges.

15. An inspection system for checking a quality of a workpiece, said inspection system comprising a computing facility as claimed in claim 14.

16. A computer program product embodied on a non-transitory computer-readable medium and comprising commands which, when loaded into a memory of a computing facility and executed by a processor of the computing facility, cause the computing facility to carry out the method of claim 9.
